(19) United States
(12) Patent Application Publication
(10) Pub. No.: US 2009/0265537 A1
(43) Pub. Date: Oct. 22, 2009

(54) COMPUTER SYSTEM, BIOS STRUCTURE AND BOOT METHOD THEREOF

(75) Inventor: Te-Chien Lin, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/424,547

(22) Filed: Apr. 16, 2009

(30) Foreign Application Priority Data
Apr. 22, 2008 (TW) 97114695

(51) Int. Cl. G06F 15/177

(52) U.S. Cl. 713/2

(57) ABSTRACT

A BIOS structure is adapted for a computer system. The BIOS structure provided by the present invention has a boot block. In addition, the boot block is divided into a stationary data sector and an updatable data sector. When the BIOS needs to be updated, program codes of the BIOS are updated from the updatable data sector. Furthermore, the computer system determines to execute the program codes of the BIOS from the stationary data sector or the updatable data sector according to a status value.

### CROSS-REFERENCE TO RELATED APPLICATION

This application claims the priority benefit of Taiwan application serial no. 97114695, filed Apr. 22, 2008. The entirety of the above-mentioned patent application is hereby incorporated by reference herein and made a part of specification.

### BACKGROUND OF THE INVENTION

1. Field of the Invention

The present invention relates to a structure of a basic input output system, particularly to a structure of a basic input output system that a boot block is divided.

2. Description of Related Art

FIG. 1 is a block diagram of a conventional computer system. Referring to FIG. 1, a conventional computer system 100 includes a central processing unit 102; a chip set 104, a memory 106, and a basic input output system (BIOS) unit 108. The central processing unit 102 is coupled to the chip set 104, through which the central processing unit 102 is coupled to the memory 106 and the BIOS unit 108.

The chip set 104 includes a north bridge chip 112 and a south bridge chip 114, wherein the north bridge chip 112 is coupled to the central processing unit 102 and the central processing unit 102 is coupled to the memory 106 and the south bridge chip 114 through the north bridge chip 112. Furthermore, the south bridge chip 114 is coupled to the BIOS unit 108. When the computer system 100 is booted, the central processing unit 102 loads the program codes in the BIOS unit 108 to the memory 106 to boot the computer.

FIG. 2 is a schematic view showing a structure of a conventional basic input output system. Referring to FIGS. 1 and 2, the conventional BIOS unit 108 includes a boot block 202, a desktop management interface (DMI) sector 204, and a main program sector 206. When the computer system 100 is booted, first program codes in the boot block 202 are executed, so as to decompress program codes of the DMI sector 204 and the main program sector 206, and to load the program codes in the memory 106 through the chip set 104.

Due to the continuous improvement of hardware technology, hardware of a computer system may require being replaced constantly. When hardware in the computer system 100 is replaced, program codes in the BIOS unit 108 may also require being updated. However, conventional BIOS updating technologies are rather unreliable. Under some situations, the updating of BIOS may fail, resulting in a failure to boot the computer. For example, during the updating of the program codes of the BIOS unit 108, the occurrence of a power failure may fail the updating, with a result that the computer system 100 is unable to be booted and a maintenance cost is required.

Therefore, in some solutions, when the BIOS unit 108 requires being updated, another storage device may be used for backing up the program codes of the BIOS unit 108. Therefore, even if the updating of the BIOS unit 108 fails, restoration may still be done by using the backup data. However, the aforementioned method not only increases the cost of hardware but also produces no efficiency.

### SUMMARY OF THE INVENTION

In view of the above, the present invention provides a computer system and a BIOS structure, under which remedial measures are carried out more conveniently without increasing the cost of hardware when the updating of BIOS fails.

In addition, the present invention also provides a boot method for the computer system, by which the computer system is booted to carry out remedial measures even when the updating of BIOS fails.

The present invention provides a BIOS structure adapted to a computer system. The BIOS of the present invention has a boot block characterized in that the boot block is at least divided into a stationary data sector and an updatable data sector. When the BIOS require updating, program codes of the BIOS is updated from the updatable data sector. In addition, the computer system determines to execute the program codes of the BIOS either from the stationary data sector or from the updatable data sector based on a status value.

Looking from another perspective, the present invention provides a computer system, which includes a central processing unit, a chip set, and a BIOS unit. The central processing unit is coupled to the chip set, through which the central processing unit is coupled to the BIOS unit. The BIOS unit has a boot block characterized in that the boot block is divided into a stationary data sector and an updatable data sector. When the BIOS require updating, the program codes of the BIOS are updated from the updatable data sector. In addition, the computer system determines to execute the program codes of the BIOS either from the stationary data sector or from the updated data sector based on a status value.

Looking from yet another perspective, the present invention provides a boot method of a computer system, including providing a basic input output system having a boot block. In addition, the boot block of the BIOS of the present invention is divided into a stationary data sector and an updatable data sector. By means of the above, the boot method of the present invention decides to execute the program codes of the BIOS from the stationary data sector or from the updatable data sector based on a status value.

In one embodiment of the present invention, when the aforementioned status value is a predetermined value, the present invention determines to execute the program codes of the BIOS from the updatable data sector. On the other hand, the present invention executes the program codes of the BIOS from the stationary data sector when the status value is 0.

In addition, the present invention sets the status value to 0 when the updating of the BIOS fails. By means of the above, even when the updating of the BIOS fails, next time when the computer system is booted, the program codes of the BIOS are executed from the stationary data sector. As a result, the computer system is still booted to a certain extent even when the data of the BIOS is damaged, allowing a user to carry out remedial measures more efficiently.

The boot block in the BIOS of the present invention is divided into a stationary data sector and an updatable data sector, wherein the BIOS does not change the data in the stationary data sector when the BIOS is updated, and thereby, even if the updating of the BIOS fails, the program codes of the BIOS can still be executed from the stationary data sector, so as to start the computer system to carry out remedial measures.

To make the above and other features and advantages of the present invention more comprehensible, several embodiments accompanied with figures are detailed as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a structural block diagram of a conventional computer system.

FIG. 2 is a schematic view showing a structure of a conventional basic input output system.

FIG. 3 is a structural block diagram of a computer system according to the first embodiment of the present invention.

FIG. 4 is a schematic view showing the structure of a basic input output system of one preferred embodiment of the present invention.

FIG. 5 is a flow chart showing the steps of a boot method of a computer system according to one preferred embodiment of the present invention.

FIG. 6 is a flow chart showing the steps of a first-time boot method according to one preferred embodiment of the present invention.

FIG. 7 is a flow chart showing the steps of a BIOS updating procedure according to one preferred embodiment of the present invention.

FIG. 8 is a structural block diagram of a computer system according to the second embodiment of the present invention.

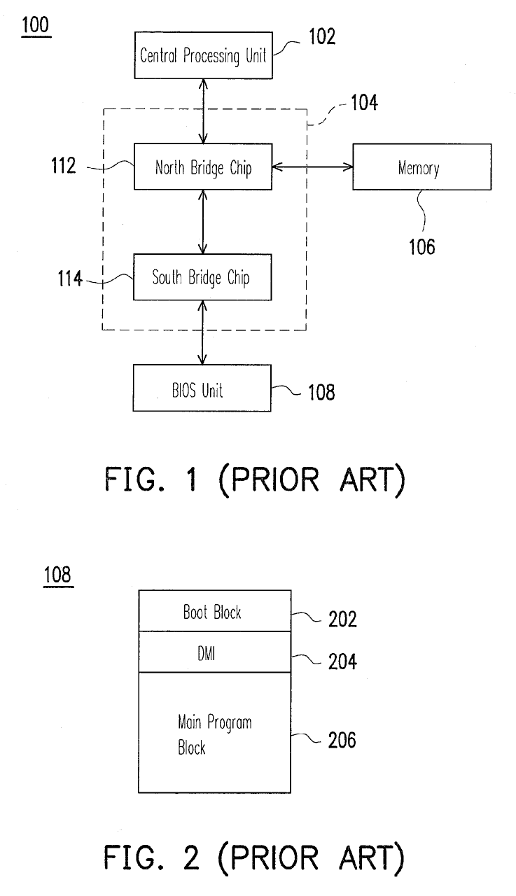

### DESCRIPTION OF EMBODIMENTS

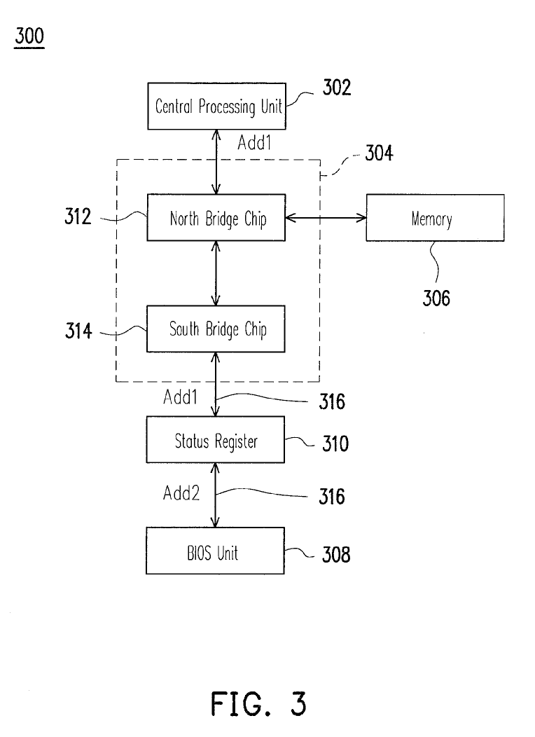

FIG. 3 is a structural block diagram of a computer system according to the first embodiment of the present invention. Referring to FIG. 3, a computer system 300 provided by this embodiment of the present invention includes a central processing unit 302, a chip set 304, a memory 306, and a BIOS unit 308. More particularly, the computer system 300 of this embodiment further includes a status register 310. In this embodiment, the central processing unit 302 is coupled to the chip set 304, through which the central processing unit is coupled to the memory 306. In addition, the chip set 304 is coupled to the BIOS unit 308 through the status register 310, wherein the status register 310 is used for storing a status value, and BIOS is embedded in the BIOS unit 308.

Generally speaking, the chip set 304 includes a north chip 312 and a south chip 314. The north bridge chip 312 is coupled to the central processing unit 302, and the central processing unit 302 is coupled to the memory 306 and to the south bridge chip 314 through the north bridge chip 312. Moreover, the south chip 314 is coupled to the status register 310 and the BIOS unit 308 through a connecting interface 316. In this embodiment, the connecting interface 316 includes a firmware hub (FWH) interface, a low pin count (LPC) interface, and a serial peripheral interface (SPI), etc. Moreover, the BIOS unit 308 may be a flash memory.

Continuing to refer to FIG. 3, when the computer system 300 is powered on, the central processing unit 302 outputs an execution address Add1, which is transmitted to the status register 310 through the chip set 304. When the status register 310 receives the execution address Add1, a mapping execution address Add2 is outputted to the BIOS unit 308 according to the status value stored internally, and thereby the BIOS unit 308 executes the program codes of the BIOS according to the mapping execution address Add2.

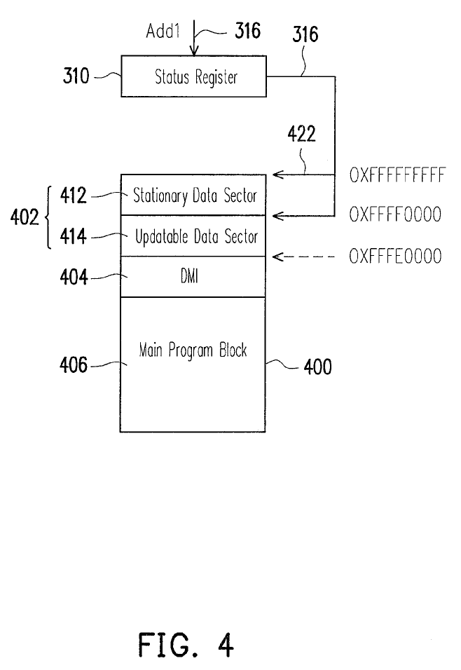

FIG. 4 is a schematic view showing the structure of a basic input output system of a preferred embodiment of the present invention. Referring to FIG. 4, a BIOS 400 provided by this embodiment is disposed in the BIOS unit 308 of FIG. 3. In this embodiment, BIOS 400 includes a boot block 402, a DMI sector 404, and a main program sector 406. Since the storage space is limited, generally data in the boot block 402 is non-compressed data, while data in the DMI sector 404 and the main program sector 406 is compressed data. The data in the boot block 402 is executed for decompressing the data of the DMI sector 404 and the main program sector 406 and loading the decompressed data in the memory 306 through the chipset 304 (as shown in FIG. 3).

Particularly, in the BIOS 400 provided by this embodiment, the boot block 402 is divided into a stationary data sector 412 and an updatable data sector 414. In this embodiment, data in the stationary data sector 412 is not updated as the BIOS 400 is updated. On the other hand, data in the updatable data sector 414 is updated as the BIOS 400 is updated. Take a flash memory of 1M bytes for example, a start address of the stationary data sector 412 may be 0xFFFFFFFF and an end address of the stationary data sector 412 may be 0xFFFF0001. In addition, a start address of the updatable data sector 414 may be 0xFFFF0000, and an end address of the updatable data sector 414 may be 0xFFFE0000.

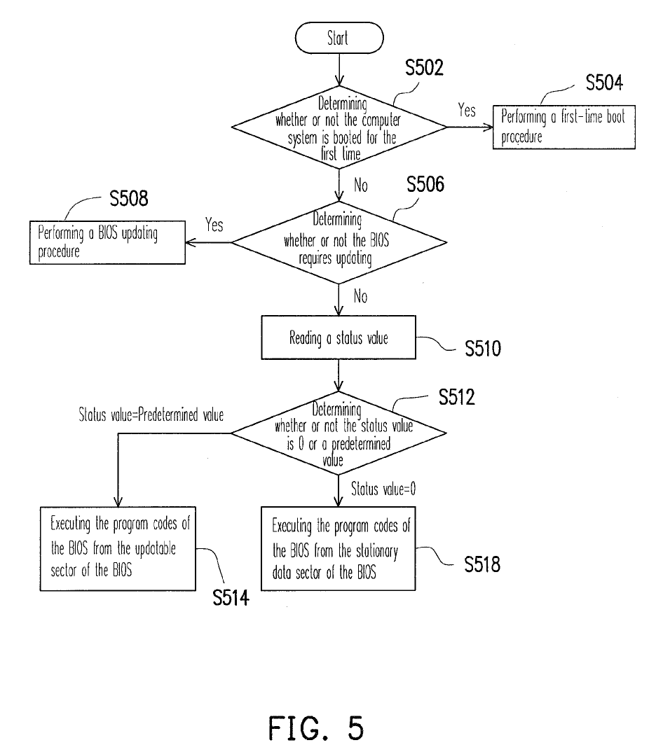

FIG. 5 is a flow chart showing the steps of a boot method of a computer system according to one preferred embodiment of the present invention. Referring to FIGS. 4 and 5, when the computer system is booted, the status register 310 receives an execution address Add1 as recited in the description of FIG. 3, and a mapping address Add2 is generated according to the status value stored internally. In this embodiment, an initial value of the status value is 0. That is to say, when the computer system is booted for the first time, the status value stored in the status register 310 is 0.

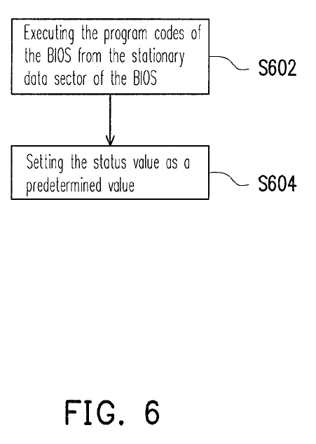

When the boot method provided by this embodiment carries out Step S502, i.e. determining whether the computer system is booted for the first time, and finds out the computer is booted for the first time (which is the “Yes” beside Step S502), a first-time power-on procedure is performed in Step S504 as shown in FIG. 6.

FIG. 6 is a flow chart showing the steps of a first-time boot method according to one preferred embodiment of the present invention. Referring to FIGS. 4 and 6, when the computer system is determined as being booted for the first time, the status value in the status register 310 may be 0. That is to say, the execution address Add1 is equivalent to the mapping execution address Add2. Meanwhile, a status flag 422 in the BIOS 400 is directed to the start address of the stationary data sector 412, for example, 0xFFFFFFFF. Judging from FIG. 6, the computer system executes the program codes of the BIOS 400 from the stationary data sector 412 as recited in Step S602. In addition, the boot method of this embodiment also carries out Step S604, which is to set the status value as a predetermined value.

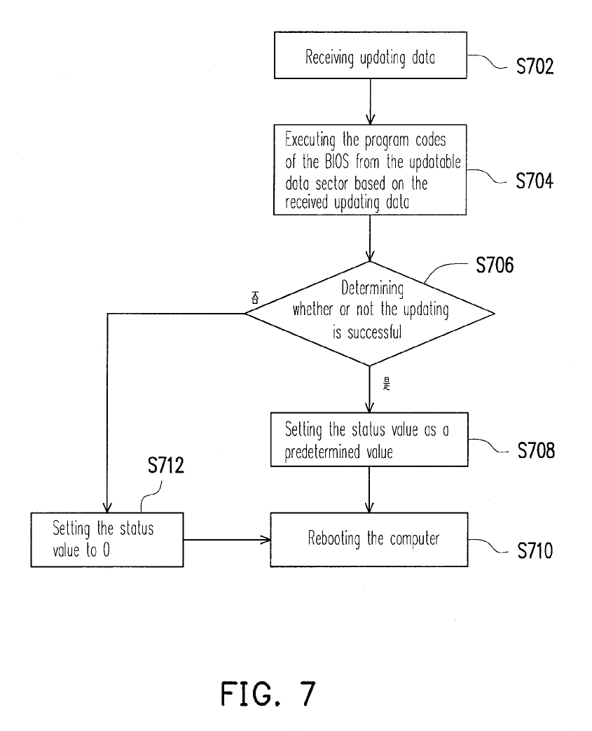

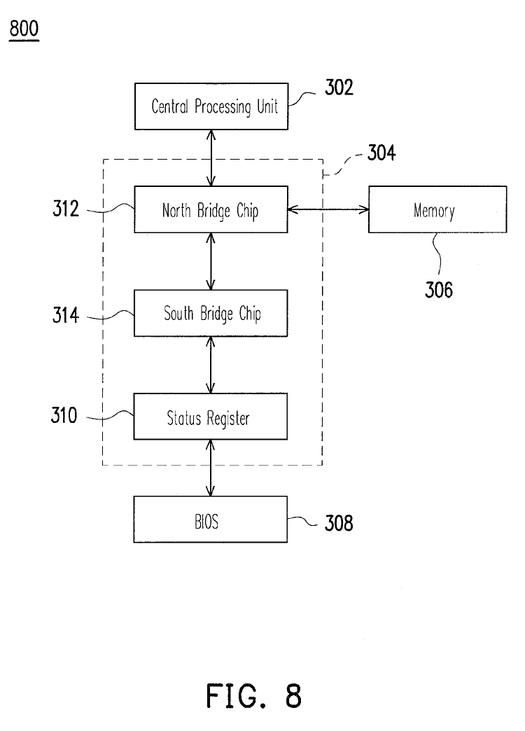

Referring to FIGS. 4 and 5 again, in Step S502, when the computer system is found out to be not booted for the first time (which is the “No” below Step S502), Step S506 is carried out, i.e. determining whether or not the BIOS 400 requires updating. If the program codes in the BIOS 400 require updating (which is the “Yes” beside Step S506), an updating procedure of Step S508 is performed as shown in FIG. 7.

FIG. 7 is a flow chart showing the steps of a BIOS updating procedure according to one preferred embodiment of the present invention. Referring to FIGS. 4 and 7, when the BIOS 400 required updating, updating data is received as recited in Step S702. Meanwhile, the status flag 422 is directed to the start address of the updatable data sector 414, for example, 0xFFFF0000, and thereby the updating procedure provided by this embodiment updates the program codes of the BIOS 400 from the updatable data sector 414 based on the received updating data as recited in Step S704. It is know from the above that the data in the stationary data sector 412 is not updated accordingly.

After Step S704 is finished, Step S706 is carried out, i.e. determining whether or not the updating of the BIOS 400 is successful. If the BIOS 400 is successfully updated (which is the “Yes” below Step S706), the status value in the status register 310, as recited in Step S708, is set as a predetermined value. In other embodiments, when Step S708 is finished, Step S710 may also be carried out, i.e. to reboot the computer system.

On the other hand, in Step S706, if the updating procedure of the BIOS 400 of this embodiment is determined as failed due to certain reasons, for example, a power failure, then Step S712 of setting the status value in the status register 310 to 0 is carried out, and the computer system is rebooted as recited in Step S710. By means of the above, next time when the computer system is booted, the program codes of the BIOS 400 are executed from the stationary data sector 412.

The data in the stationary data sector 412 is not changed as the BIOS 400 is updated. Therefore when the updating of the BIOS 400 fails, the computer system is still booted to a certain extent by executing the data in the stationary data sector 412. As a result, a user can perform remedial measures to restore the data in the BIOS 400.

Referring back to FIGS. 4 and 5, in Step S506, when the BIOS 400 is not found out requiring any updating (which is the “No” below Step S506), the status value in the status register 310 is read as recited in Step S510 and is determined as 0 or a predetermined value as recited in Step S512. If the status value is a predetermined value, the program codes of the BIOS 400 are executed from the updatable data sector 414 as recited in Step S514. On the other hand, if the status value of the status register 310 is set to 0 due to, for example, the aforementioned reason that causes failure in updating, the program codes of the BIOS 400 are executed from the stationary data sector 412 as recited in Step S518.

The second embodiment of the present invention is provided below.

FIG. 8 is a structural block diagram of a computer system according to the second embodiment of the present invention. Referring to FIG. 8, the status register 310 does not require much space; therefore in a computer system 800 provided in this embodiment, the status register 310 is disposed in the chip set 304. In other embodiments, the status register 310 may even be realized by using the space in the south bridge chip 314. Therefore, the computer system 800 provided by this embodiment does not increase additional costs of hardware.

Based on the above, since the boot block in the BIOS of the present invention is divided into the stationary data sector and the updatable data sector, even when the updating of BIOS fails, the computer system is still booted by using the data in the stationary data sector so as to conduct remedial measures. In addition, since the status register may be disposed in the chip set or even be realized by using the space in the south bridge chip, no additional cost of hardware is required.

Although the present invention has been disclosed by the above embodiments, they are not intended to limit the present invention. Anybody skilled in the art may make some modifications and alterations without departing from the spirit and scope of the present invention. Therefore, the protection range of the present invention falls in the appended claims.

What is claimed is:

1. A computer system, comprising:
a central processing unit;
a chip set coupled to the central processing unit; and
a basic input output system unit coupled to the chip set and having a boot block, the boot block being divided into a stationary data sector and an updatable data sector,
wherein, when the central processing unit loads program codes of the basic input output system unit, the central processing unit determines to execute the program codes of the basic input output system from one of the stationary data sector and the updatable data sector based on a status value.

2. The computer system according to claim 1, wherein the program codes of the basic input output system are updated from the updatable data sector when the basic input output system is updated.

3. The computer system according to claim 1, wherein data in the stationary data sector and in the updatable data sector is non-compressed data.

4. The computer system according to claim 1, wherein the basic input output system further comprises a desktop management interface sector and a main program sector.

5. The computer system according to claim 4, wherein data in the desktop management interface sector and the main program sector is non-compressed data.

6. The computer system according to claim 1 further comprises a status register disposed on a data transmitting path between the chip set and the basic input output system for storing the status value.

7. The computer system according to claim 1, wherein the chip set comprises:
a north bridge chip coupled to the central processing unit; and
a south bridge chip coupled to the north bridge chip and to the basic input output system.

8. The computer system according to claim 7, wherein the chip set further comprises a status register disposed on a data transmitting path between the south bridge chip and the basic input output system for storing the status value.

9. The computer system according to claim 1, wherein the basic input output system is coupled to the chip set through one of a firmware hub interface, a low pin count interface, and a serial peripheral interface.

10. A boot method of a computer system, comprising:
providing a basic input output system having a boot block;
dividing the boot block into a stationary data sector and an updatable data sector; and
determining to execute program codes of the basic input output system from one of the stationary data sector and the updatable data sector based on a status value.

11. The boot method according to claim 10, further comprising:
executing the program codes of the basic input output system from the updatable data sector when the status value is a predetermined value; and
executing the program codes of the basic input output system from the stationary data sector when the status value is 0.

12. The boot method according to claim 10, further comprising:
determining whether or not the computer system is booted for the first time;
executing the program codes of the basic input output system from the stationary data sector when determining the computer system is booted for the first time; and
setting the status value as a predetermined value.

13. The boot method according to claim 10, further comprising:
determining whether or not the basic input output system requires updating;
receiving updating data when the basic input output system requires updating;
updating the program codes of the basic input output system from the updatable data sector according to the received updating data;
determining whether or not the basic input output system is updated successfully; and
setting the status value as a predetermined value when determining the basic input output system is updated successfully.

14. The boot method according to claim 13, further comprising rebooting the computer system when the basic input output system is updated successfully.

15. The boot method according to claim 13, comprising setting the status value to 0 when the basic input output system is updated unsuccessfully, so that the program codes of the basic input output system are executed from the stationary data sector when the computer system is booted next time.

16. The boot method according to claim 15, further comprising rebooting the computer system when the basic input output system is updated unsuccessfully and the status value is set to 0.

17. The boot method according to claim 10, wherein the basic input output system further comprises a desktop management interface sector and a main program sector.
